(19) United States
(12) Patent Application Publication
(10) Pub. No.: US 2015/0340849 A1
(43) Pub. Date: Nov. 26, 2015

(54) MANUAL CABLE CUTTER

(71) Applicant: TOA INTERSYSTEM INC., Niigata (JP)

(72) Inventors: Minoru KOCHI, Niigata (JP); Sadayoshi KOBAYASHI, Niigata (JP); Hiroshi OYANAGI, Niigata (JP)

(21) Appl. No.: 14/711,131

(22) Filed: May 13, 2015

(30) Foreign Application Priority Data
May 26, 2014 (JP) 2014-108497

(51) Int. Cl. H02G 1/00; B23D 21/06; A01G 3/02; B23D 29/02

(52) U.S. Cl. CPC H02G 1/005; B23D 29/023; B23D 21/06; A01G 3/02

(57) ABSTRACT

A manual cable cutter in which a fulcrum of at least one handle is set to a projecting piece provided to a cutting blade connected to the other handle; a middle portion of the one handle and a rear end portion of the cutting blade are connected through a slider mechanism, and a point of the connection is set as an action point of the handle; an angle between the fulcrum of the handle, and a contact point between the cutting blades is set in an appropriate range; and a ratio among a length between the center of the support shaft and the fulcrum of the handle, a length between the fulcrum and the action point of the handle, and a length between the action point of the handle and the center of the support shaft is set in an appropriate range.

### BACKGROUND

1. Technical Field

The present invention relates to a manual cable cutter which cuts a cable such as a wire, a power line and a communication line, and a red-like material or a tube-like material such as a steel pipe, a rebar, wood and a tree branch.

### RELATED ART

A manual cable cutter of the related art is configured to include a pair of cutting blades pivotally supported by a support shaft in a rotatable manner, and a pair of handles each of which is connected to each rear end portion of the cutting blades, and cut a cable or the like by rotating each cutting blade in a closing direction through a rotation operation of each of the handles with the support shaft as a fulcrum.

Since a manual cable cutter is a tool to be operated by a manual force, it is desirable to enable cutting of the cable or the like with a force as small as possible. As described in Japanese Design Registration No. 1375224, the applicant has already developed a manual cable cutter capable of reducing a force required for operation of a handle at the time of cut, and completed the design registration.

The manual cable cutter of Japanese Design Registration No. 1375224 is configured to include a pair of cutting blades pivotally supported by a support shaft in a rotatable manner, and a pair of handles each of which is connected to each rear end portion of the cutting blades; to set a fulcrum as a rotation center of one handle of the pair of handles to a projecting piece provided in the cutting blade connected to the other handle; to connect a middle portion of the one handle and a rear end portion of the cutting blade as a target, to be connected through a slider mechanism; and to set a point of the connection as an action point of the one handle so that the action point is set between the fulcrum and a power point of the one handle. Thus, according to such a configuration, it is possible to apply a rotation force to the cutting blade by causing a force larger than a force added to the power point of the one handle to act on the action point, and to cut a cable or the like with a smaller force.

### SUMMARY

As described above, the manual cable cutter of Japanese Design Registration No. 1375224 is configured such that the action point is set between the fulcrum and the power point of the one handle by intentionally displacing the fulcrum as the rotation center of the one handle from a center of the support shaft as a rotation center of the cutting blade, connecting the middle portion of the one handle to one cutting blade through the slider mechanism and setting a point of the connection as the action point of the handle, and thus, is capable of applying the rotation force to the cutting blade with the smaller force by utilizing a so-called principle of a second type lever.

Further, the manual cable cutter of Japanese Design Registration No. 1375224 may convert the action point which linearly moves inside the slider mechanism into the rotation movement of the cutting blade with favorable efficiency by the slider mechanism.

However, the applicant has found out that an effect according to the manual cable cutter of Japanese Design Registration No. 1375224 is limited by the configuration of setting the fulcrum and the action point, and as a result of intensive studies, has conceived the present invention by discovering a configuration of the fulcrum and the action point which may exhibit, the effect to the full extent.

The present invention follows the configuration of the manual cable cutter of Japanese Design Registration No. 1375224, and is added with a configuration for sufficiently exhibiting the effect according to the configuration.

To sum up, a manual cable cutter according to the present invention includes: a pair of cutting blades which is pivotally supported by a support shaft in a rotatable manner; and a pair of handles each of which is connected to each rear end portion of the cutting blades, and causes the connected cutting blades to rotate, and has the following configurations A to D:

A: a fulcrum as a rotation center of at least one handle of the pair of handles is set to a projecting piece provided to the cutting blade connected to the other handle, a middle portion of the one handle and a rear end portion of the cutting blade as a target to foe connected are connected through a slider mechanism, and a point of the connection is set as an action point of the handle so that the action point is set between the fulcrum and a power point of the one handle;

B: a contact point between the fulcrum of the one handle, and a rear end portion of the other cutting blade in the rear end portion of the cutting blade connected to the one handle is set to an angle, which is larger than 0 degree and smaller than ISO degrees, having a center of the support shaft as a vertex;

C: in a case where the angle is larger than 0 degree and equal to or smaller than 30 degrees, a ratio among a length between the center of the support shaft and the fulcrum of the one handle, a length between the fulcrum and the action point of the one handle, and a length between the action point of the one handle and the center of the support shaft is set to be 0.4 to 2.4:3.0 to 5.0:3.6 to 5.6; and

D: in a case where the angle is larger than 90 degrees and smaller than 180 degrees, the ratio among the length between the center of the support shaft and the fulcrum of the one handle, the length between the fulcrum and the action point of the one handle, and the length between the action point of the one handle and the center of the support shaft, is set to be 0.2 to 2.2:3.6 to 5.6:3.2 to 5.2.

Preferably, the projecting piece is a separate body from the cutting blade to which the projecting piece is provided so that it is possible to eliminate a need for manufacturing a dedicated cutting blade, and further, to provide the pair of cutting blades in a common shape.

More preferably, it is configured such that the projecting piece has a fixing portion and is fixed to the cutting blade through the fixing portion by welding or is fixed to the cutting blade through the fixing portion by bolting.

In the case where the projecting piece is fixed to the cutting blade by bolting, it is also possible to bore a plurality of bolt holes for the bolting in the cutting blade so that a fixing position of the projecting piece is adjustable using the plurality of bolt holes.

Further, it is configured such that a convex blade portion is provided to a middle portion of the blade portion in a front end portion of one cutting blade, and an arcuate blade portion is provided between the convex blade portion and a proximal end of the blade portion so that it is possible to reliably catch and cut an outer peripheral surface of a cable or the like as a target to be cut.

According to the manual cable cutter according to the present invention, it is possible to rotate the cutting blade with a force equal to or larger than a force added to the handle, and reduce a burden of an operator.

Further, it is possible to more reliably cut the cable or the like by giving the blade portion of a special shape to the cutting blade.

### BRIEF DESCRIPTION OF DRAWINGS

FIG. 1 is a front view of a manual cable cutter according to Embodiment 1;

FIG. 2 is a cross-sectional view taken along line A-A of FIG. 1;

FIG. 3 is an enlarged view illustrating a pair of cutting blades in a closed state;

FIG. 4 is a back view of the manual cable cutter according to Embodiment 1;

FIG. 5A is an enlarged view illustrating a fixing example of a projecting piece provided to the cutting blade, and FIG. 5B is a cross-sectional view taken along line B-B of FIG. 5A;

FIG. 6A is an enlarged view illustrating another fixing example of the projecting piece provided to the cutting blade, and FIG. 6B is a cross-sectional view taken along line C-C of FIG. 6A;

FIG. 7 is a front view of the manual cable cutter according to Embodiment 1 in which the pair of cutting blades is in an opened state; and

FIG. 8 is a back view of a manual, cable cutter according to Embodiment 2.

### DETAILED DESCRIPTION

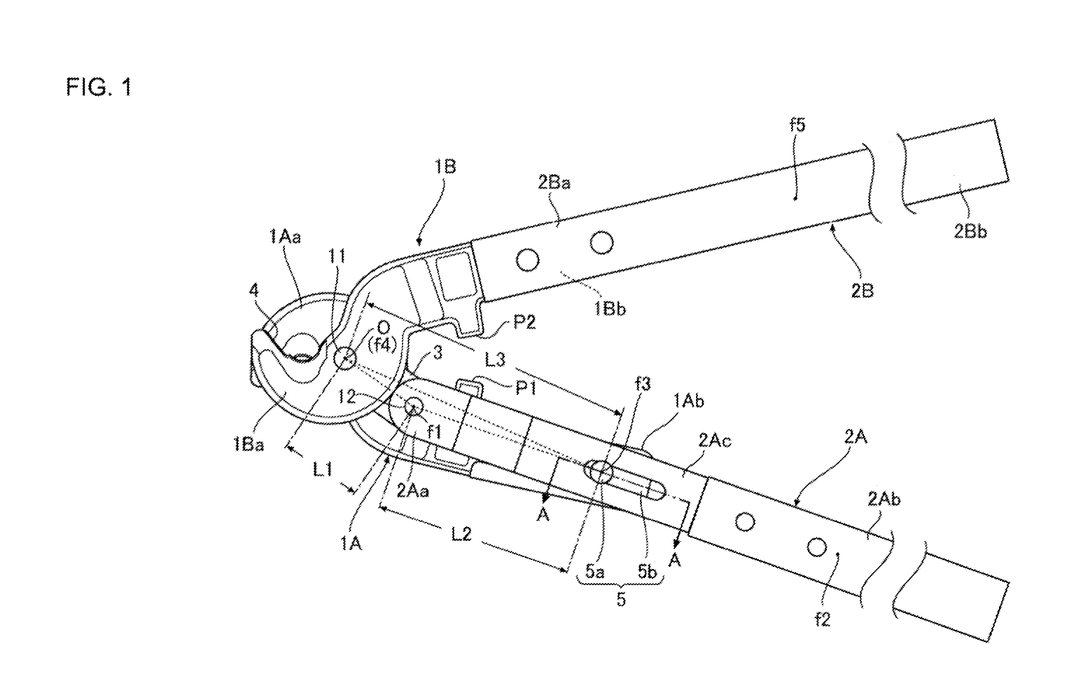

Hereinafter, the best mode of the present invention will be described -with reference to FIGS. 1 to 8.

### Embodiment 1

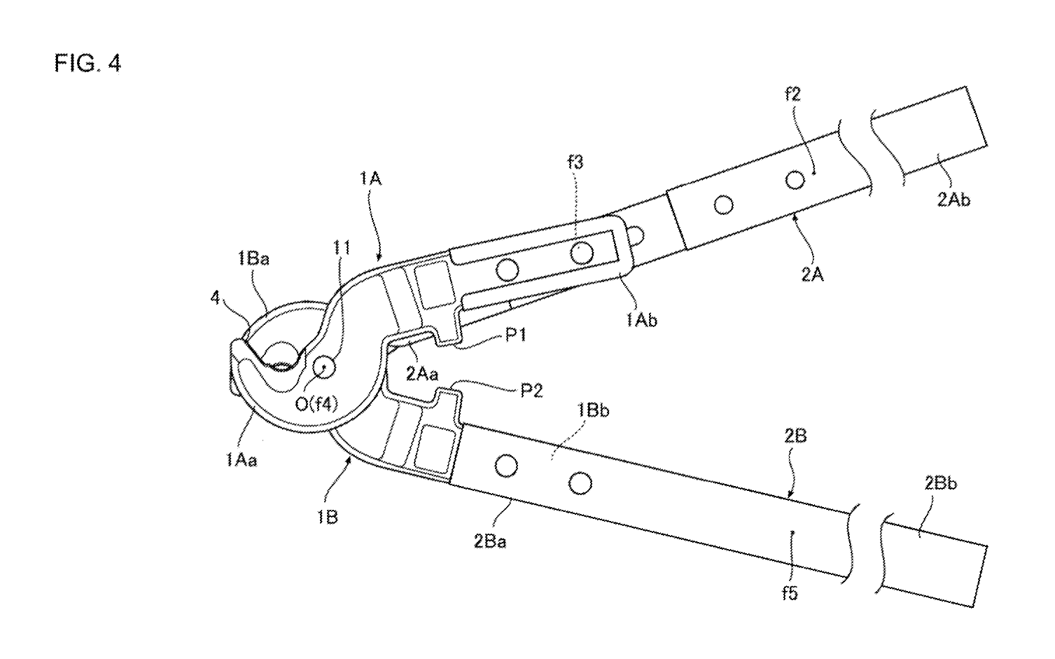

As illustrated in FIGS. 1 and 4, a manual cable cutter according to Embodiment 1 has a basic configuration which is provided with a pair of the cutting blades 1A and 1B pivotally supported by a support shaft 11 in a rotatable manner, and a pair of handles 2A and 28 which is connected to rear end portions 1Ab and 1Bb of the cutting blades 1A and 1B, respectively and causes the connected cutting blades to rotate. Further, the pair of cutting blades 1A and 1B has blade portions 4 configured to cut a cable or the like, respectively, at front end portions 1Aa and 1Ba.

In addition, it is configured such that a fulcrum f1 as a rotation center of one handle 2A of the pair of handles 2A and 28 is set to a projecting piece 3 provided to the cutting blade 1B connected to the other handle 2B. That is, the front end portion 2Aa of the handle 2A is pivotally supported by the projecting piece 3 provided to the cutting blade 1B via a handle shaft 12, and a center of the handle shaft 12 is set as the fulcrum f1. Incidentally, an operator grips the rear end portion 2Ab of the one handle 2A and performs rotation operation of the handle, and thus, a power point f2 of the one handle 2A is set to the rear end portion 2Ab.

Next, the projecting piece 3 provided to the above-described cutting blade 1B will be described. The projecting piece 3 may be provided integrally with the cutting blade 1B, provided with the projecting piece 3, but in Embodiment 1, a description will be made regarding a case where the projecting piece 3 is provided as a separate body from the cutting blade 1B. In this manner, it is configured such that the projecting piece 3 is provided as a separate body from the cutting blade 1B so that there is no need to manufacture a dedicated cutting blade 1B with which the projecting piece 3 is integrated, and further, it is possible to form, the pair of cutting blades 1A and 1B in a common shape.

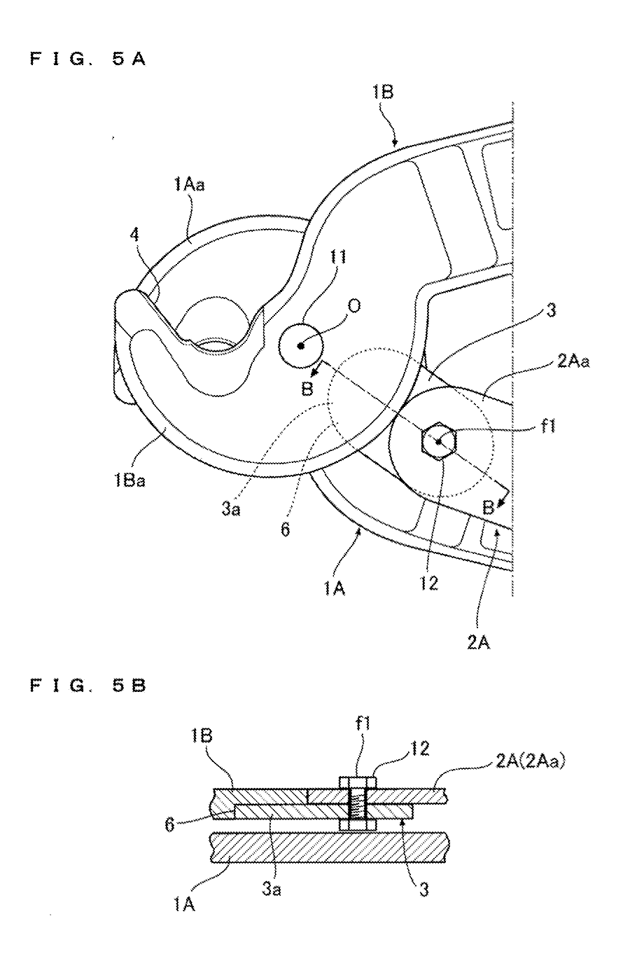

The projecting piece 3 has an elliptical plate shape, one end portion, thereof is provided with the handle shaft 12, and the other end portion thereof has a fixing portion 3a. The projecting piece 3 is fixed to the cutting blade 1B through the fixing portion 3a by welding. For example, as illustrated in FIGS. 5A and 5B, the projecting piece 3 is fixed to the cutting blade 1B by fitting and welding the fixing portion 3a of the projecting piece 3 to a concave portion 6 formed on a rear surface of the cutting blade 1B. Incidentally, the present invention does not exclude a case where the concave portion 6 is hot formed in the cutting blade 1B, and the fixing portion 3a of the projecting piece 3 is directly welded to a front surface or the rear surface of the cutting blade 1B. Further, the projecting piece 3 is not limited to the elliptical plate shape as long as capable of having the fixing portion 3a.

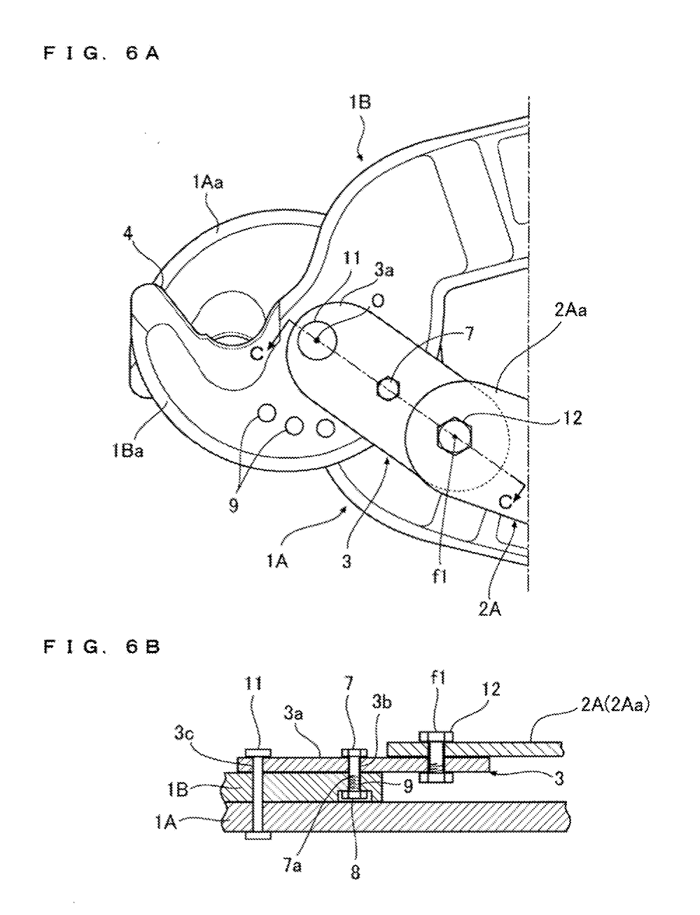

Further, as illustrated in FIGS. 6A and 6B, as another fixing example of the projecting piece 3, the filing portion 3a of the projecting piece 3 is fixed to the cutting blade 1B by bolting. More specifically, a bolt hole 9 is bored in the cutting blade 1B, and further, a bolt hole 3b is bored also in the fixing portion 3a of the projecting piece 3. Then, a bolt 7 is inserted penetrating into the bolt holes 9 and 3b, and a nut 8 is screwed into a front end of the bolt 7 thereby bolting them. In addition, a hole 3c for the support shaft is bored in one fixing portion 3a of the projecting piece 3, and then the support shaft 11 is inserted, penetrating into the hole 3c so as to pivotally support both the cutting blades 1A and 1B together.

The bolt hole 9 bored in the cutting blade 1B is bored in plural in an arcuate shape having a center O of the support shaft 11 as a reference and configured to be capable of adjusting the fixing position of the projecting piece 3.

Further, as described above, according to the configuration in which the projecting piece 3 is fixed to the cutting blade 1B by bolting, a shaft 7a of the bolt 7 functions as a breaker which prevents damage of the pair of cutting blades 1A and 1B. That is, in a case where a cable as a target to be out is strong and the blade portions 4 of the cutting blade 1A and 1B seem to be damaged when a force equal to or greater than the hardness of the cable is applied to the pair of cutting blade's 1A and 1B which are in contact with an outer peripheral surface of the cable, the shaft 7a of the bolt 7 is actively broken thereby blocking transmission of the force from the one handle 2A to one cutting blade 1A.

Further, as illustrated in FIG. 1, in the manual cable cutter according to Embodiment 1, a middle portion 2Ac of the one handle 2A and a rear end portion 1Ab of the cutting blade 1A as a target to be connected are connected through a slider mechanism 5, and a point of the connection is set as an action point f3 of the one handle. Accordingly, it is configured such that the action point f3 is set between the fulcrum f1 and the power point f2 of the one handle 2A.

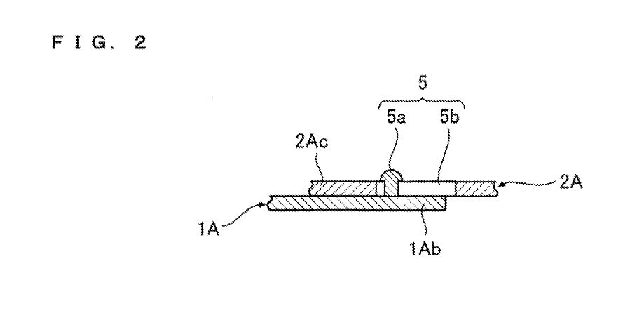

As illustrated in FIG. 2, the slider mechanism 5 is made up of a slider shaft 5a provided to the rear end portion 1Ab of the one cutting blade 1A, and a slider groove 5b bored in the middle portion 2Ac of the one handle 2A, and connects the one cutting blade rear end portion 1Ab and the one handle middle portion 2Ac. Further, a center of the slider shaft 5a is set as the action point f3 of the one handle 2A.

The slider shaft 5a linearly moves inside the slider groove 5b and rotates along with the rear end portion 1Ab of the one cutting blade 1A. In other words, a force applied to the action point f3 of the one handle 2A is converted to a rotation force of the one cutting blade 1A. Incidentally, in Embodiment 1, an example is illustrated in which the slider shaft 5a forming the slider mechanism 5 is provided to the one cutting blade rear end portion 1Ab, and the slider groove 5b is provided to the one handle middle portion 2Ac, but the present invention is not limited thereto. A configuration in which the slider groove 5b is provided to the one cutting blade rear end portion 1Ab, and the slider shaft 5a. is provided to the one handle middle portion 2Ac may be optional depending on an embodiment.

Further, as illustrated in FIGS. 1 and 4, in the other handle 2B of the manual cable cutter according to Embodiment 1, a front end portion 2Ba thereof is connected to a rear end portion 1Bb of the other cutting blade 1B facing the one cutting blade IA by bolting. Accordingly, the center 0 of the support shaft 11, which pivotally supports the other cutting blade 1B, is set as a fulcrum f4. Further, a power point f5 of the other handle 2B is set in the rear end portion 2Bb of the handle

As described above, in Embodiment 1, the fulcrum f1 as the rotation center of the one handle 2A is set to be actively displaced from the center O of the support shaft 11 as the rotation center of the one cutting blade 1A connected to the handle. Further, the middle portion 2Ac of the one handle 2A is connected to the rear end portion 1Ab of the one cutting blade 1A through the slider mechanism 5, and a point of the connection is set as the action point 13 of the handle. Accordingly, the action point f3 is set between the fulcrum f1 and the power point f2 of the one handle 2A, and it is possible to apply the rotation force to the cutting blade 1A with a small force and favorable efficiency.

In addition, the manual cable cutter according to Embodiment 1 may exhibit the above-described effect to the full extent through the configuration further limiting a setting configuration of the fulcrum f1, the power point 12 and the action, point f3 of the one handle 2A.

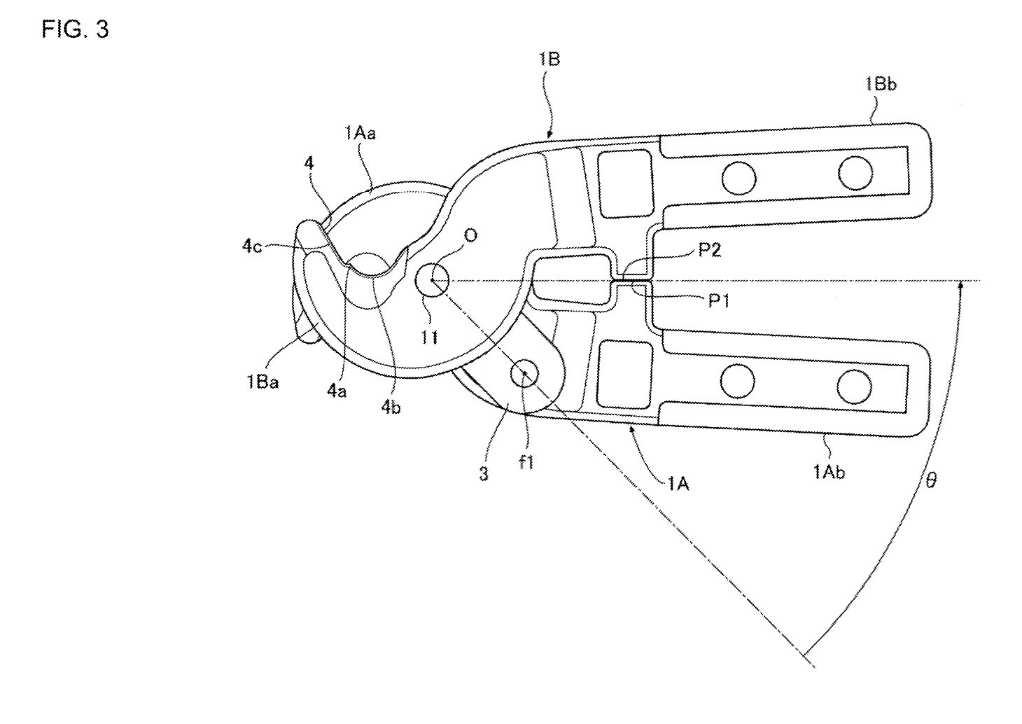

In ether words, as illustrated in FIG. 3, the manual cable cutter according to Embodiment 1 is configured to set the contact point Pi between the fulcrum, f1 of the one handle 2A, and the rear end portion 1Bb Of the other cutting blade 1B in the rear end portion 1Ab of the cutting blade 1A connected to the one handle 2A no an angle θ, which is larger than 0 degree and smaller than 180 degrees, having the center O of the support shaft 11 as the vertex.

It is possible to ensure smooch rotation of the one handle 2A and the one cutting blade 1A by setting 0<θ<180 as described above. In addition, it is possible to sufficiently obtain an effect of rotating the cutting blade 1A with a smaller force, that is, an effect of reducing a burden of an operator in cooperation with the configuration in relation to an interval between the center O of the support shaft, the fulcrum f1 and the action point f3 to be described hereinafter.

In a case where the angle θ is larger than 0 degree and equal to or smaller than 90 degrees (0<θ≦90), a ratio among a length L1 between the center O of the support shaft 11 illustrated in FIG. 1 and the fulcrum f1 of the one handle 2A, a length L2 between the fulcrum, f1 and the action point f3 of the handle, and a length L3 between the action point f3 of the handle and the center O of the support shaft 11 is set to be 0.4 to 2.4:3.0 to 5.0:3.6 to 5.6.

Further, in a case where the angle θ is larger than 90 degrees and smaller than 180 degrees (90<0<180), a ratio among the length L1 between the center O of the support shaft 11 illustrated in FIG. 1 and the fulcrum f1 of the one handle 2A, the length L2 between the fulcrum f1 and the action point f3 of the handle, and the length L3 between the action point f3 of the handle and the center O of the support shaft 11 is set to be 0.2 to 2.2:3.6 to 5.6:3.2 to 5.2.

The manual cable cutter according to Embodiment 1, as described above, may reduce the burden of the operator by applying the force added to the one handle 2A to the one cutting blade 1A with favorable efficiency through the configuration in relation to the above-described range of the angle θ, and the configuration in relation to the interval between the fulcrum f1, the power point f2 and the action point f3.

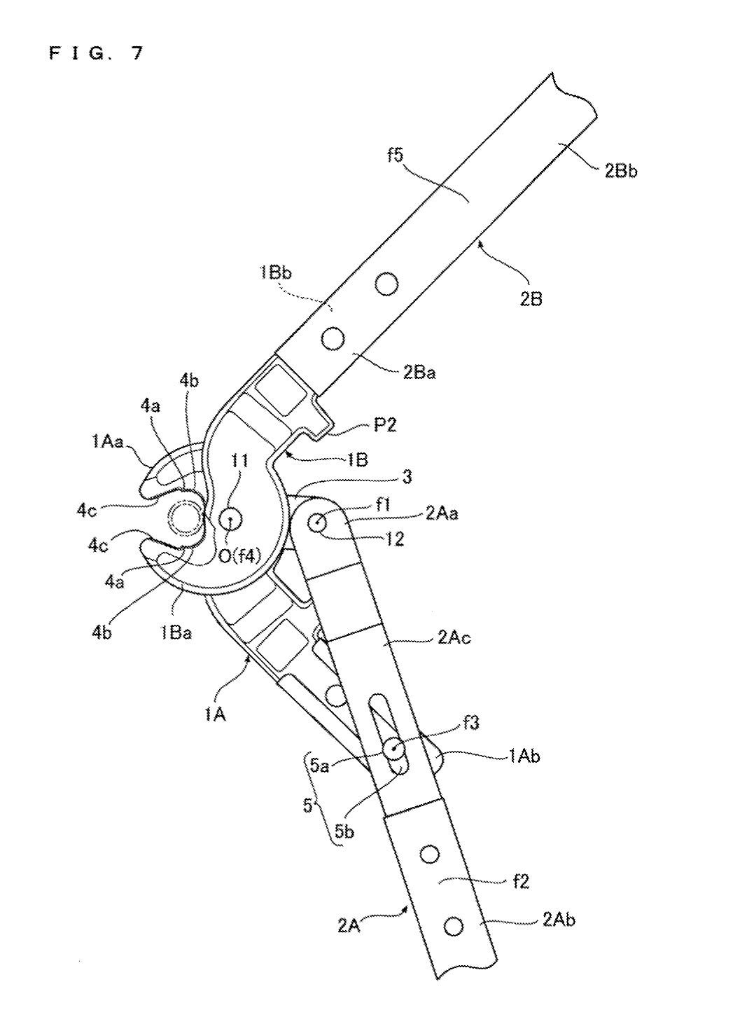

Lastly, a description will be made regarding a configuration of the blade portions 4 of the pair of cutting blades 1A and 1B. As illustrated in FIGS. 3 and 7, the blade portion 4 is configured such that a convex blade portion 4a is provided at the middle portion thereof, and an arcuate blade portion 4b is provided between the convex blade portion 4a and a proximal end of the blade portion. Further, it is configured such that a linear blade portion 4c is provided between the convex blade portion 4a and a front end of the blade portion.

At the time of use, it is possible to guide and receive the cable or the like as the target to be cut by the linear blade portion 4c, and grip and reliably cut the outer peripheral surface of the cable or the like by the convex blade portion 4a and the arcuate blade portion 4b. Further, at an initial stage of cutting, the convex blade portion 4a bites the outer peripheral surface of the cable or the like to start cutting while achieving prevention of missing.

### Embodiment 2

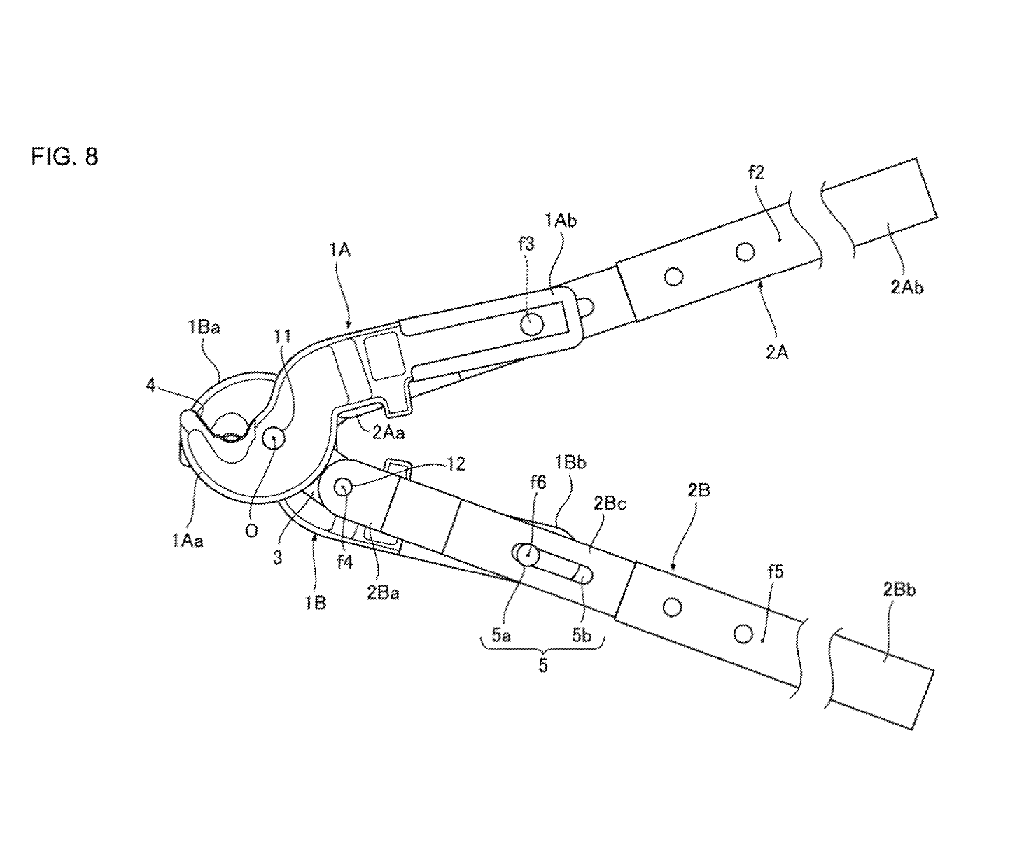

A manual cable cutter according to Embodiment 2 has the same basic configuration as Embodiment 1. A difference is that it is not configured such that only the fulcrum, of the one handle 2A is displaced from the center O of the support shaft 11 as illustrated in Embodiment 1, but is configured such that, in addition to the above configuration, the fulcrum 14 of the other handle 2B is also displaced from the center O of the support shaft 11 similarly to the one handle 2A as illustrated in FIG. 8.

In other words, in Embodiment 2, since the configuration in relation to the fulcrum f1, the power point f2 and the action point f3 in the one handle 2A is the same as in Embodiment 1, the description in Embodiment 1 is incorporated here.

Further, the configuration in relation to the fulcrum f4, the power point f5 and an action point f6 of the other handle 2B is also the same as the technical idea in the one handle 2A.

In other words, it is configured such that the fulcrum f4 as a rotation center of the other handle 2B is set to the projecting piece 3 provided to the cutting blade 1A connected to the one handle 2A, a middle portion 2Bc of the other handle 2B and the rear end portion 1Bb of the cutting blade 1B as a target to be connected are connected through the slider mechanism 5, and a point of the connection is set as the action point f6 of the other handle. Accordingly, the configuration is provided in which the action point f6 is set between the fulcrum f4 and the power point f5 of the other handle 2B.

Further, a contact point P2 between the fulcrum f4 of the other handle 2B, and the rear end portion 1Ab of the one cutting blade 1A in the rear end portion 1Bb of the cutting blade 1B connected to the other handle 23 is set to an angle θ, which is larger than 0 degree and smaller than 180 degrees, having the center O of the support shaft 11 as the vertex.

Further, a configuration in relation to an interval between the support shaft center O, the fulcrum f4 and the action point f6 of the other handle 2B is the same as the configuration in relation to the interval between the support shaft center O, the fulcrum f1 and the action point f3, which has already been described in Embodiment 1, and thus, the description thereof will be omitted here.

In addition, the configuration in relation to the fixation of the projecting piece 3 and the shape of the blade portion 4 is also the same as that in Embodiment 1.

As described above, the manual cable cutter according to the present invention may rotate the cutting blade with a force equal to or larger than a force added to the handle, and reduce the burden of the operator in either embodiment.

Further, it is possible to more reliably cat the cable or the like by giving the blade portion of a special shape to the cutting blade.

Incidentally, in the present application, a numerical range that indicates a gap between a lower limit value and an upper limit value using “to” represents the entire numeric value (integer values and fractional values) between the lower limit value and the upper limit value.

1. A manual cable cutter comprising:
a pair of cutting blades which is pivotally supported by a support shaft in a rotatable manner; and
a pair of handles each of which is connected to each rear end portion of the cutting blades, and causes the connected cutting blades to rotate, wherein
the manual cable cutter has the following configurations A to D:
A: a fulcrum as a rotation center of at least one handle of the pair of handles is set to a projecting piece provided to the cutting blade connected to the other handle, a middle portion of the one handle and a rear end portion of the cutting blade as a target to be connected are connected through a slider mechanism, and a point of the connection is set as an action point of the handle so that the action point is set between the fulcrum and a power point of the one handle;
B: a contact point between the fulcrum of the one handle, and a rear end portion of the other cutting blade in the rear end portion of the cutting blade connected to the one handle is set to an angle, which is larger than 0 degree and smaller than 180 degrees, having a center of the support shaft as a vertex;
C: in a case where the angle is larger than 0 degree and equal to or smaller than 90 degrees, a ratio among a length between the center of the support shaft and the fulcrum of the one handle, a length between the fulcrum and the action point of the one handle, and a length between the action point of the one handle and the center of the support shaft is set to be 0.4 to 2.4:3.0 to 5.0:3.6 to 5.6; and
D: in a case where the angle is larger than 90 degrees and smaller than 180 degrees, the ratio among the length between the center of the support shaft and the fulcrum of the one handle, the length between the fulcrum and the action point of the one handle, and the length between the action point of the one handle and the center of the support shaft is set to be 0.2 to 2.2:3.6 to 5.6:3.2 to 5.2.

2. The manual cable cutter according to claim 1, wherein
the projecting piece is a separate body from the cutting blade to which the projecting piece is provided.

3. The manual cable cutter according to claim 2, wherein
the projecting piece has a fixing portion and is fixed to the cutting blade through the fixing portion by welding.

4. The manual cable cutter according to claim 2, wherein
the projecting piece has a fixing portion and is fixed to the cutting blade through the fixing portion by bolting.

5. The manual cable cutter according to claim 4, wherein
a plurality of bolt holes for the bolting is bored in the cutting blade, and a fixing position of the projecting piece is adjustable using the plurality of bolt holes.

6. The manual cable cutter according to claim 1, wherein
a convex blade portion is provided to a middle portion of a blade portion in a front end portion of the cutting blade, and an arcuate blade portion is provided between the convex blade portion and a proximal end of the blade portion.

7. The manual cable cutter according to claim 2, wherein
a convex blade portion is provided to a middle portion of a blade portion in a front end portion of the cutting blade, and an arcuate blade portion is provided between the convex blade portion and a proximal end of the blade portion.

8. The manual cable cutter according to claim 3, wherein
a convex blade portion is provided to a middle portion of a blade portion in a front end portion of the cutting blade, and an arcuate blade portion is provided between the convex blade portion and a proximal end of the blade portion.

9. The manual cable cutter according to claim 4, wherein
a convex blade portion is provided to a middle portion of a blade portion in a front end portion of the cutting blade, and an arcuate blade portion is provided between the convex blade portion and a proximal end of the blade portion.

10. The manual cable cutter according to claim 5, wherein
a convex blade portion is provided to a middle portion of a blade portion in a front end portion of the cutting blade, and an arcuate blade portion is provided between the convex blade portion and a proximal end of the blade portion.
